(19) United States
(12) Patent Application Publication
(10) Pub. No.: US 2007/0068068 A1
(43) Pub. Date: Mar. 29, 2007

(54) Insect trap device

(76) Inventors: Robert W.J. Weiss, Julian, PA (US); Gunter Muller, Freising (DE); E. Cole Nelson JR., Lakewood, IL (US)

Correspondence Address: BRINKS HOFER GILSON & LIONE, P.O. BOX 10395, CHICAGO, IL, 60610, US

(21) Appl. No.: 11/588,923

(22) Filed: Oct. 27, 2006

Related U.S. Application Data
(62) Division of application No. 11/097,034, filed on Apr. 1, 2005.
(62) Division of application No. 11/094,034, filed on Mar. 30, 2005, now abandoned.

(51) Int. Cl. A01M 1/20

(52) U.S. Cl. 43/132.1

(57) ABSTRACT

A device is disclosed for trapping mosquitoes. The device includes a housing, a bag and a fan located in the housing. The fan creates capture zone with an air flow towards the bag. A plurality of light sources attract mosquitoes to the capture zone. The light sources include an ultraviolet light, a plurality of light emitting diodes, and an incandescent light. A heat source also attracts the mosquitoes to the capture zone.

### CROSS REFERENCE TO RELATED APPLICATION

The present application is a Divisional of U.S. application Ser. No. 11/094,034, filed Mar. 30, 2005, which is incorporated by reference herein.

### FIELD OF THE INVENTION

This invention relates to insect trap devices, including but not limited to mosquito traps.

### BACKGROUND

Biting insects, such as mosquitoes, can be annoying and in some instances carry disease. Reports are on the rise of mosquito transferred West Nile virus. West Nile virus can be spread by the bite of an infected mosquito, and can infect people, horses, many types of birds, and some other animals. On some occasions, a West Nile virus infection can result in severe and sometimes fatal illnesses.

Known devices are used to attempt to destroy or repel the mosquitoes such as bug zappers and electronic repellers. Many bug zappers rely upon ultraviolet light to draw insects through an electrified wire grid. A burst followed by crackling sounds signals that the insect has passed through the electrocuting device. Bug zappers may kill many insects, but few of the insects killed are pests. Most of the insects are beetles or night-flying moths. Mosquitoes may make up a small percentage of bug zapper collections since mosquitoes can be scared away by the electronic wire grid of the bug zappers.

Other traps require the use of propane tanks to produce carbon dioxide to attract the mosquitoes. Such use of propane tanks, however, can make the trap hard to set up and use. Other traps require carbon dioxide tanks. The carbon dioxide tanks, however, may not be readily available to the average consumer.

### BRIEF SUMMARY

A device is disclosed for trapping mosquitoes. The device includes a housing, a bag and a fan located in the housing. The fan creates capture zone with an air flow towards the bag. A plurality of light sources attract mosquitoes to the capture zone. The light sources include an ultraviolet light, a plurality of light emitting diodes, and an incandescent light. A heat source also attracts the mosquitoes to the capture zone.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a front view of a mosquito trap.

FIG. 2 is a front partial cut-away view of the mosquito trap.

FIG. 3 is a bottom perspective partial cutaway view of the heat attractant module and cap.

FIG. 4 is a perspective view of the flap.

FIG. 5 is a partial side cutaway view of the heat attractant module and the cap.

FIG. 6 is a partial side cutaway perspective view of the heat attractant module and the cap.

FIG. 7 is a visual guide that can be placed under the cap.

FIG. 8 is another arrangement of the mosquito trap.

FIG. 9 is a diagram of exemplary positioning of the mosquito traps.

### DETAILED DESCRIPTION

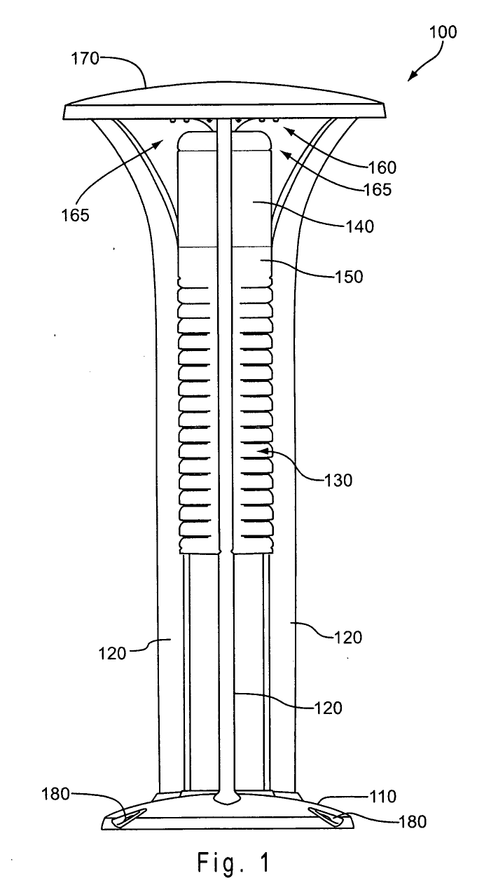

FIG. 1 is a front view of a trap 100 for catching mosquitoes and/or other insects. The trap 100 can be used to attract mosquitoes and/or other insects, and trap them. The mosquitoes can be trapped by consumers that do not wish to be bitten by them, or others, such as scientists that wish to trap mosquitoes to study them. The trap 100 can use a variety of lure or attractants to help attract different varieties of mosquitoes which may by their nature be attracted to different types of attractants.

The trap 100 can include a base 110. The base 110 can be used to support legs 120 and the legs 120 can support a housing 130. Connected to the housing is a heat attractant module 140. The heat attractant module 140 includes a contrasting layer 150. The trap 100 can also include a light attractant module 160. A cap 170 can cover the light attractant module 160. The heat attractant module 140 and the light attractant module 160 attract mosquitoes to a capture zone 165.

The trap 100 can be manufactured of a plastic, such as a plastic that does not continue to emit chemicals due to a long cure time since some chemicals from plastic can repel mosquitoes. The plastic can include suitable UV stabilizers to allow for extended outdoor use, and can be not brittle or easy to crack.

The base 110 can include openings 180 that accommodate stakes to hold the trap 100 to the ground. The openings 180 can also accommodate other objects to hold the base 100 in place, such as bolts set in concrete. The openings can be placed over the bolts and nuts can be used to secure the base in place. The legs 120 can be extendable to create a height of about two to about four feet high. Alternatively, instead of placing the trap 100 on legs 120 and a base 110, the trap 100 can be hung from cables attachable to the cap 170. Other supports can be used such as brackets, wires and forms.

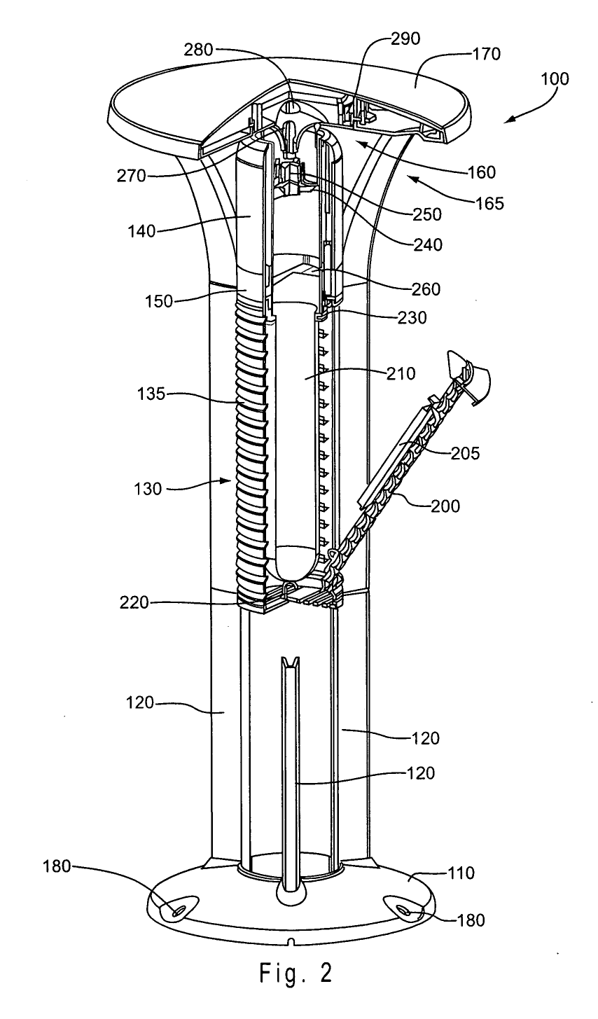

FIG. 2 is a front partial cut-away side view of the trap 100. The housing 130 can include an access panel 200 to allow access to an inside of the housing 130. A side of the access panel 200 can be attached to the housing 130 by a hinge to allow the access panel 200 to be opened without completely removing the panel. The inside of the housing 130 can accommodate a bag 210 to hold mosquitoes or other insects that are caught by the trap 100. If hung, the housing 130 can be omitted and the bag 210 can be allowed to hang freely. An exemplary bag includes a fine mesh bag. The bag 210 may be manufactured from polyester and nylon, such as one manufactured by Nanjing Whole-Win Textiles Co., Ltd. Located in Jingsu Province, China. The bag 210 can be disposable and/or re-usable. The mosquitoes can be allowed to desiccate within the bag. Alternately, the mosquitoes can be kept alive for survey samples by using a larger area bag with moistened cotton-balls. A bottom of the housing 130 can include a hook 220 to hold a bottom of the bag 220 in place in the housing 130. A top of the bag 220 can be secured to a ring 230 located by the contrasting layer 150.

The heat attractant module 140 can accommodate a fan 240 and a motor 250 for turning the fan 240. The motor 250 can be positioned above or below the fan 240. An exemplary fan includes a three inch diameter fan manufactured by Thorgren of Valparaiso, Ind., and an exemplary motor includes a motor model number RF-500TB manufactured by Mabuchi Motor America Corp, located in Troy, Mich. The motor can be powered in different ways such as with a low voltage line, or in other ways, such as with batteries and/or a solar panel. The low voltage line can provide about twelve volts alternating current (AC) to the trap 100. The trap 100 can be connected to a MALIBU lighting system. The MALIBU system can be used to turn the trap 100 on and off at preset times.

The fan 240 can create the capture zone 165 by forcing air in a downward direction such that mosquitoes that are attracted to the trap 100 can be forced down into the bag 220. The distance between the cap 170 and the air intake includes about three-quarters to one and three-eights. A smaller the distance between the cap 170 and the air intake provides a higher velocity of air created by the fan 240. In some versions of the trap 100, the distance between the cap 170 and the air intake can be adjustable. Air flow created by the fan 240 should be strong enough to overcome the flying power of the mosquitoes but not so strong that the air flow from the fan 240 scares away the mosquitoes. A flap valve 260 can be located near the top of the bag 210. The flap valve 260 can be forced open when the fan 240 is on so that the mosquitoes can blow past the flap valve 260 and into the bag. The flap valve 260 can close when the fan 240 is off so that the mosquitoes cannot fly back out of the bag 210.

The portion of the housing 130 that covers the bag 210 can include openings 135, such as louvers, to allow air to pass from the fan 240 though the bag 210 and then out of the housing 130. The openings 135 can be arranged to allow the air to exit the hosing 130 but to keep elements, such as rain, out of the housing 130. The access panel 200 can be constructed to hold a cartridge 205, such as a cartridge 205 containing a chemical attractant. The chemical attractant can include octenol, lactic acid or other mosquito attractants. Other types of mosquito attractants can be used such as carbon dioxide, which can be provided by dry ice. The carbon dioxide can be warmed, such as by flowing the carbon dioxide past the heat attractant module 140.

The light attractant module 160 can include varying light sources such as an incandescent light source 270, an ultraviolet light source 280, and light emitting diodes (LEDs) 290. The incandescent light source 270 can include a bulb or LED to produce visible light between the cap 170 and fan opening. An exemplary incandescent light source 270 includes a 4 Watt light bulb. The visible light can include a color, such as yellow. The incandescent light source 270 can provide general attraction to a wide area. The ultraviolet source 280 can include a UV_{B} light source such as a four watt fluorescent bulb. Other sized or frequency ultraviolet sources 280 can also be used, such as UV_{A} or UV_{C} light sources. The frequency of the UV_{B} light is about 280 to 320 nanometers (nm). The ultraviolet source 280 can be recessed in the cap 170 to limit the attraction of non-target species that might otherwise be attracted to the ultraviolet light. The emitted UV_{B} light can shine down, such as in a conical shape, around the trap 100.

The LEDs 290 can be arranged in an array around the cap 170. Various numbers of LEDs 290 can be used, such as eight LEDs of varying color. Different colored LEDs can attract different species of mosquitoes. The colors can include amber orange (about 610 nm), violet (about 380 nm), green (about 565 nm) and blue (about 470 nm). Other colors could also be used such as red (about 670 nm) and yellow (587 nm). An accuracy of the color of the LED 290 can include plus or minus approximately twenty-five nanometers. If eight LEDs are used, two of each color can be used. One sequencing includes blue, yellow, blue and then wither orange or yellow. The LEDs 290 shine down towards the heat attractant module. The LEDs 290 can cycle on and off, such as one color at a time, three to five seconds per color to attract mosquitoes. The LEDs 290 can be used to simulate movement by operating in sequence and/or flickering. The rate of flickering includes about 100 to 200 Hz, such as 150 Hz. Each frequency may attract different species of mosquitoes.

The heat attractant module 140 includes a heat film or blanket to regulate the heat attractant module to approximately 42 degrees C. (about 107 degrees F.) plus or minus 1 degree C. Other heat sources can be used such as an incandescent bulb. Other temperatures can be used such as about 100 to about 110 degrees F. The heat film can be placed within the heat attractant module 140. An exemplary heat film is manufactured by CPC Hi-Technologies Ltd., located in Yoqneam, Israel. A plastic shell/cylinder can be used as a thermal mass for the heat attractant module 140. The shell can also be manufactured from other materials, such as metal. The heat attractant module 140 can include a dark color, such as black. Other dark colors could be used, such as blue, green or red. The heat attractant module 140 can include a roughened surface so that mosquitoes can land on the film. The dark heat attractant module 140 can contrast in color with non-dark or lighter color, such as white silver or grey, of the contrasting layer 150. Mosquitoes can be attracted to the change from a dark to a lighter color. The heat attractant module 140 can provide a mottled thermal appearance, similar to that of a blood target.

Switches and valves can be provided to allow operators to further control the trap 100. The switches can be used to control elements of the light attractant module 160 and/or the heat attractant module 140. For example, in some versions the heat produced by the heat attractant module 140 can be adjusted when on and/or turned off. In addition, lights of the light attractant module can be turned on and off. The switches can also be used to turn the LEDs 290 on and off. Moreover, the incandescent light source 270 and the ultraviolet light source 280 can be turned on or off by the operator, such that the LEDs 290, incandescent light source 270, and ultraviolet light source 280 can be turned on or off in any combination. The valves can be used to allow the operator to connect a source of carbon dioxide to the trap.

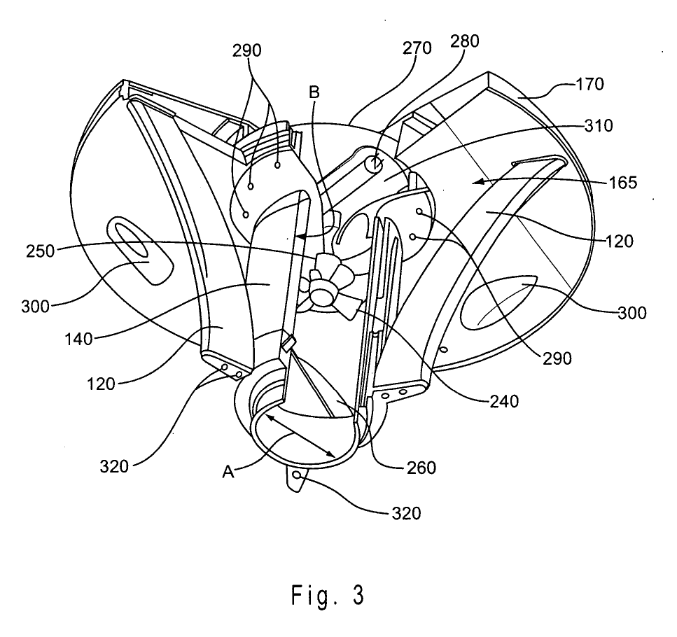

FIG. 3 is a bottom perspective partial cutaway view of the heat attractant module 140 and cap 170. The cap 170 can include indentations to be used as handles 300 to carry the trap 100. The fluorescent light 280 can be recessed into the cap 170 and at least partially surrounded by a generally semi-circular shaped reflector 310 to reflect the UV_{B} light downward. By recessing the fluorescent light 280 into the cap 170 other insects such as moths and beetles may not be attracted to the trap 100. The legs 120 can include holes 320 to accommodate mating with lower portions of the legs, such as with pegs or dowels. The flap 260 is located in a partially open position within a tube A having an inner diameter, such as an inner diameter of approximately three inches. The size is implementation dependent and other sizes can be used. Tube B can include an inner diameter bigger than the inner diameter of Tube A, such as to include a five inch diameter.

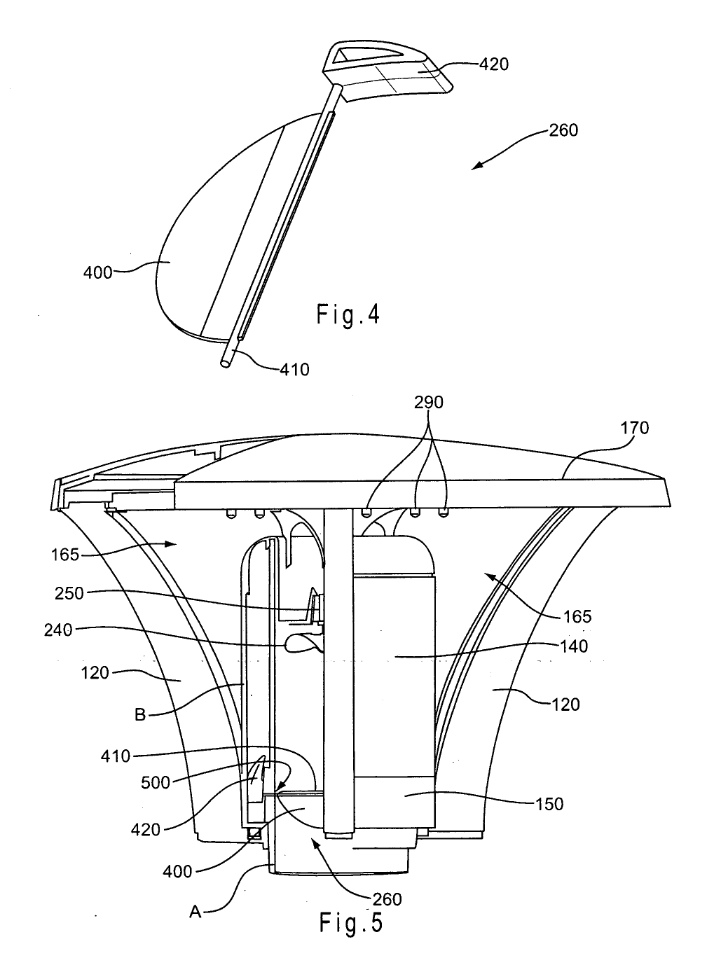

FIG. 4 is a perspective view of the flap 260. Two flaps 260 can be positioned side-by-side to cover substantially all of Tube A. Each flap 260 includes a flap portion 400, a rod 410 and a counterbalance 420. The flap 260 is weighted to favor the closed position which is generally perpendicular to a direction of flow of Tube A. When the fan 240 is operated, air flow from the fan 240 can push on a surface of the flap portion 400 and overcome the weight of the counterbalance 420 to push the flap portion 400 to be arranged in a direction generally parallel to the flow of the Tube A.

FIG. 5 is a partial side cutaway view of the heat attractant module 140 and the cap 170. The counter balance 420 can be protected by tube B from the elements such as rain and dirt. The counter balance 420 is sized to be able to pivot in the area between the outside diameter of tube A and the inside diameter of Tube B. The rod 410 connecting the counter balance 420 to the flap portion 400 can be positioned through an opening 500 in the wall of Tube A. In this way the counter balance 420 can remain out of the flow of air and out of the view of consumers.

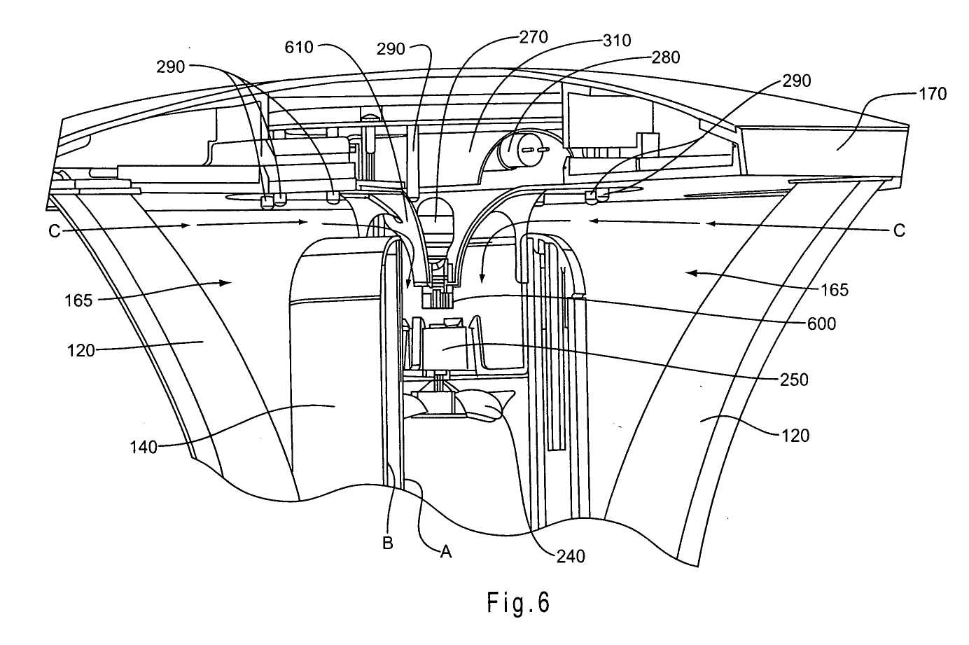

FIG. 6 is a partial side cutaway perspective view of the heat attractant module 140 and the cap 170. The incandescent light source 270 can plug in to a bulb holder 600 to be energized. A lens 610 protects the incandescent light source 270. The lens 610 can be shaped to have smooth, curved outer surface. The lens 610 can be manufactured from a material, such as plastic, that allows free passage of the light emitted by the incandescent light source 270. The lens 610 can include a focusing or non-focusing lens. The lens 610 is manufactured of a material that allows ultraviolet wavelength light to pass without filtering the ultraviolet light. The outer surface of the lens 610 can be shaped to create a venturi effect of the air flow being driven by the fan 240. To create the venturi effect to the air under the cap 170, the lens 610 can include a nozzle-like shape to cause an increase in the velocity of the air flow towards the bag 210. The curved surface of the lens 610 can create a smooth air flow since an otherwise turbulent air flow can scare away the mosquitoes.

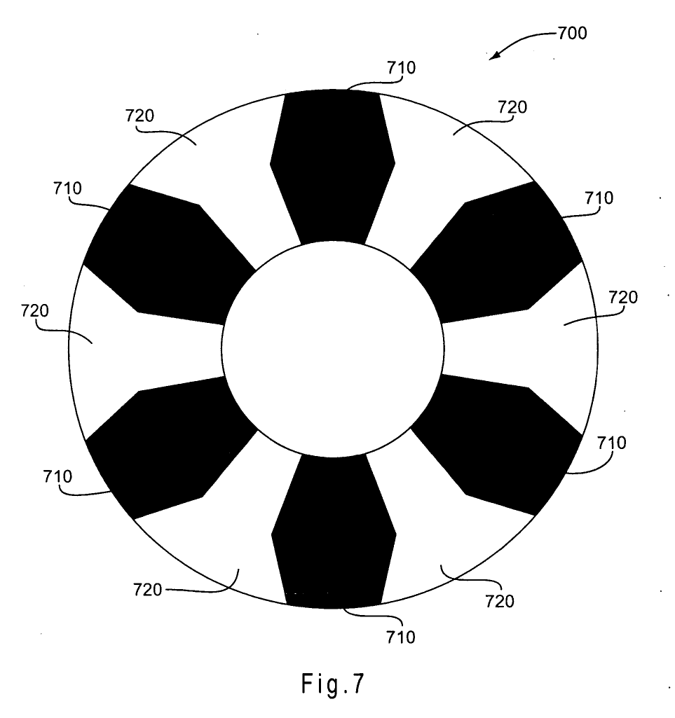

FIG. 7 is a visual guide 700 that can be placed under the cap 170. The guide 700 can include alternating pattern which act to guide the mosquitoes toward the fan 240. The pattern includes a dark color 710, such as black, and alternating light color 720, such as white. Other dark colors could be used, such as blue, green or red. Alternatively, the colors of the pattern can be reversed such that the shown dark colored pattern is a light color and the light colored pattern is dark color. The pattern can be painted directly onto the bottom of the cap 170 or placed on the cap 170 in other ways such as with a decal.

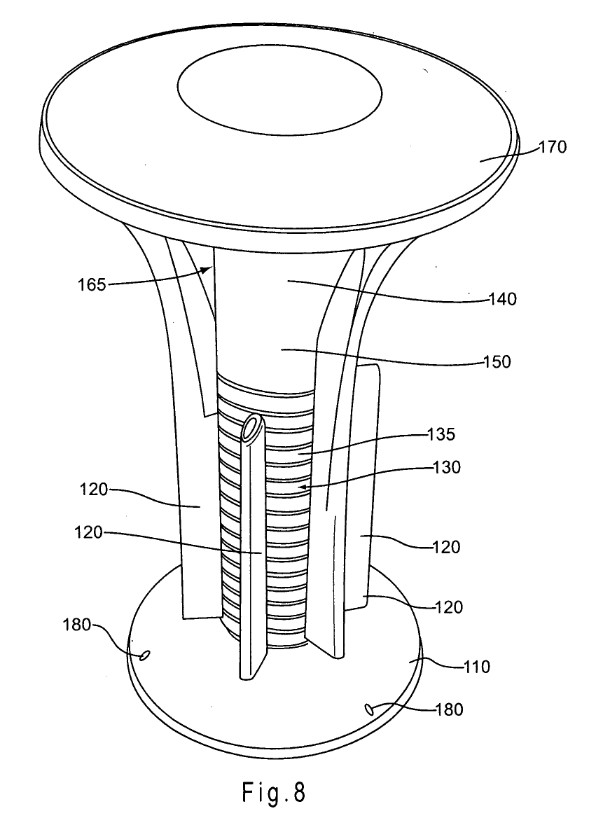

FIG. 8 is another arrangement of the trap 100. The trap 100 can be separated, such as at the legs 120, to allow for a shorter version of the trap 100. If separated at the legs 120 and turned, the housing can be dropped to the base 110. Moreover, in this or other arrangements, the cap 170 can be opened to allow replacement of parts such as the incandescent bulb or fluorescent bulb. The cap 170 can include a hinge so that the cap 170 remains attached to the trap 100 when opened. A switch, such as an interlock switch, can be connected with the cap 170 such that, when the cap 170 is opened, power to the trap 100 is shut off.

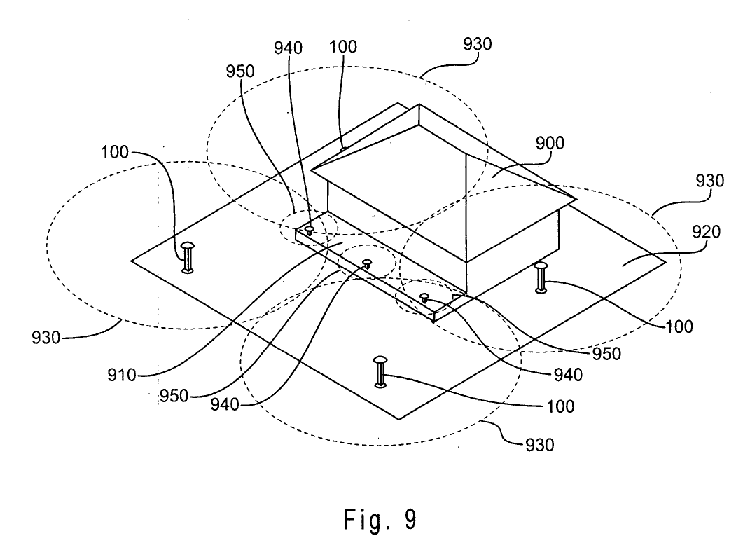

FIG. 9 is a diagram of exemplary positioning of the traps 100. The traps 100 can be used to trap mosquitoes in designated areas, such as at a residence of the consumer. The consumer may have a house 900 with a deck or a pool 910 and a lot 920. To protect the deck 910 from mosquitoes, the consumer can place two to four traps 100 around the perimeter of the area to be protected. Other arrangements of traps 100 can also be used. Each trap 100 has a trapping range 930. By placing the traps around the perimeter of the area to be protected, conditions, such as wind and location of the mosquitoes, need not be considered. Mosquito repelling devices 940 which have a repel zone 950 can be used in combination with the traps 100 to repel the mosquitoes away from the area to be protected by the consumer, and/or towards the traps 100.

It is to be understood that changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

We claim:

1. A device for attracting mosquitoes, comprising:
a housing;
a plurality of light sources connected with the housing, wherein the light source comprises an ultraviolet light, a plurality of light emitting diodes, and an incandescent light;
a visual target connected with the housing, the visual target comprising alternating dark and light patterned targets; and
a heat source connected with the housing.

2. The device of claim 1 further comprising a cap connected with the housing.

3. The device of claim 2 wherein the ultraviolet light is covered by the cap such that the ultraviolet light is observable only from beneath the cap.

4. The device of claim 1 further comprising a lens to cover the incandescent light.

5. The device of claim 4 wherein the lens includes a curved surface to produce a venturi effect to air that flows past the lens.

6. The device of claim 1 further including a flap valve to trap mosquitoes within the housing.

7. The device of claim 6 wherein the flap valve opens when air is flowing to the housing and the flap valve otherwise closes.

8. The device of claim 6 wherein the flap valve includes a counterbalance and a flap portion.

9. The device of claim 8 wherein the counterbalance is located outside the flow of air and the flap portion is located within the flow of air.

10. The device of claim 1 wherein the light emitting diodes flicker at a frequency of about 100 Hz to about 200 Hz.
